(19) United States
(12) Patent Application Publication
(10) Pub. No.: US 2003/0216825 A1
(43) Pub. Date: Nov. 20, 2003

(54) Method for transmitting data from a data network to a telecommunication terminal

(76) Inventor: Frank-Uwe Andersen, Berlin (DE)

Correspondence Address: LERNER AND GREENBERG, P.A., POST OFFICE BOX 2480, HOLLYWOOD, FL, 33022-2480, US

(21) Appl. No.: 10/407,715

(22) Filed: Apr. 4, 2003

(30) Foreign Application Priority Data
Apr. 4, 2002 (DE) 102 14 930.5

(51) Int. Cl. G06F 17/00

(52) U.S. Cl. 700/94

(57) ABSTRACT

A method for transmitting data from a data network to a telecommunication terminal and delivery at the telecommunication terminal in audio format. The method involves the data being transmitted to a server, the format of the information being converted to a binary audio format on the server and being transmitted to a voice transmission gateway using the push access protocol, and the information being transmitted from the voice transmission gateway, following conversion to a suitable format, in the voice band to a telecommunication terminal via a telecommunication network and being output in audio form.

### BACKGROUND OF THE INVENTION

1. Field of the Invention

The invention lies in the telecommunications field. More specifically, the invention relates to a method for transmitting data from a data network to a telecommunication terminal, with the data being output on the telecommunication terminal in audio form.

Connection of a data domain, e.g. in the form of the Internet, to the telecommunication domain, specifically of mobile radio networks, has become more and more important in recent times. To use the information and services on the Internet, e.g. e-mail, in the area of mobile radio technology, the “WAP” (Wireless Application Protocol) standard is used. This standard uses a multilayer protocol architecture to provide a standard basis for using wireless IP (Internet Protocol) services, specifically irrespective of the actual radio interface, with the technical prerequisite for Internet communication being satisfied merely by access to a mobile radio network, a mobile telephone with a multiline text display and a microbrowser.

WAP can be used to retrieve content provided on the Internet and to load it onto the mobile telephone. This operation, where data are sent only upon retrieval, is universally referred to as “pull” for short. If one now wishes to send data from the Internet to a mobile telephone, whether they be messages provided by an information service, advertising which a supplier sends to his customers from the Internet, or in the simplest case an e-mail or SMS, then this operation, which involves no data being requested but rather being sent “spontaneously,” is referred to as “WAP push.”

In the case of WAP push, in line with the current standard WAP 1.2, the data are transmitted on the Internet using the “push access protocol”. The interface between the Internet and the mobile radio network forms a “push proxy gateway”, from where the data are sent to the mobile telephone of a WAP customer using the push-over-the-air (OTA) protocol. This push-over-the-air protocol is based on the very complex structure of the wireless session protocol (WSP), the communication protocol on the session layer of the WAP protocol architecture.

At present, a connection between WAP Internet and “voice” is generally produced using the VoiceXML (Voice Extensible Markup Language) protocol. This permits Internet pages having “voice capability” and even dialogs, but an appropriate mechanism for a corresponding VoiceXML WAP push is not yet available.

In the standard presented above for WAP push, it is possible to transmit text messages from the Internet which contain, by way of example, a URL for an Internet page to which the customer can surf. A drawback of the standard, however, is that it is not possible to send “voice message calls”, that is to say messages which are output on a mobile telephone in the form of speech, using WAP push.

Another drawback of the existing method is that the messages received by a mobile telephone, whether in the form of a WAP content, an SMS or an e-mail, need to be called up in a first step in order to be output as text on the display so that they can then be read in a second step. The first part is sometimes a great problem particularly for older people who are not so familiar with operating a mobile telephone but need one professionally, for example. For reading a text message, there can sometimes be situation-related obstacles, e.g. receiving a message while driving a car, which means that output of the message in the form of speech is a great advantage in this case (and also in the first one).

Another drawback of the prior art formed by the standard WAP 1.2 is that messages from the Internet can be received only using a specially equipped mobile telephone, a mobile with “WAP capability.” That means that a large number of users of conventional mobile telephones cannot use the corresponding opportunities for combining Internet with telecommunication.

### SUMMARY OF THE INVENTION

It is accordingly an object of the invention to provide a method of transmitting data from a data network to a telecommunications terminal which overcomes the above-mentioned disadvantages of the heretofore-known devices and methods of this general type and which is developed to provide a simple, user-friendly and inexpensive method and system for transmitting data from a data network for convenient output on a conventional telecommunication terminal.

With the foregoing and other objects in view there is provided, in accordance with the invention, a method for transmitting data from a data network to a telecommunication terminal, which comprises:

transmitting the data in the data network to a server;

converting a format of the data to a binary audio format on the server;

transmitting the data in audio format to a voice transmission gateway with a WAP push using push access protocol;

converting the data from the audio format to a format for transmission in the voice band with the voice transmission gateway; and

transmitting the data in the voice band to the telecommunication terminal via a telecommunication network, for outputting in audio format on the telecommunication terminal.

In accordance with an added feature of the invention, the data are converted on the server to a PCM-WAV format.

In accordance with an additional feature of the invention, the data in audio format on the server are appended to a push access protocol message using MIME coding.

In accordance with another feature of the invention, the voice transmission gateway receives and decodes messages in push access protocol format on an HTTP basis.

In accordance with another preferred embodiment of the invention, the data are transmitted from the voice transmission gateway to the telecommunication terminal in the voice channel using DSP technology.

In accordance with a further feature of the invention, data originally in the form of music or sounds are transmitted from the data network to the telecommunication terminal. Alternatively, data that are originally in a text format are transmitted from the data network to the telecommunication terminal.

In accordance with a concomitant feature of the invention, the data are output from the data network using a conventional telecommunication terminal, particularly one without WAP capability.

With the above and other objects in view there is provided, in accordance with the invention, a network for transmitting data from a data network to a telecommunication terminal, the network comprising:

a server connected to receive the data in data format and having a device for converting the data to an audio format and a device for transmitting messages in push access protocol format; and

a voice transmission gateway with an HTTP-based reception device for receiving and decoding messages in push access protocol format and a transmission device for transmitting data to the telecommunication terminal in a voice channel.

A fundamental concept of the invention relates to the server-end conversion of the format of the data which are to be transmitted from a data network to a telecommunication terminal into a binary audio format. Another fundamental feature of the invention is that essentially the WAP push standard based on the prior art is used for transporting the data within the data network.

Another basic feature of the invention relates to the transmission of the data which are now in binary audio format to a voice transmission gateway by means of WAP push using the push access protocol, from which voice transmission gateway the data are transmitted, following conversion of the audio format to a suitable format, in the voice band to a telecommunication terminal via a telecommunication network. In addition, the invention encompasses the basic concept of the data being output on the telecommunication terminal in audio form (audibly).

In one embodiment of the invention, data in text format are preferably converted to a binary audio format following arrival on the server. The audio data are advantageously appended to a PAP message using MIME coding and are transmitted to the voice transmission gateway, with an HTTP-based implementation allowing communication between said voice transmission gateway and the server using the push access protocol.

On the voice transmission gateway, this PAP message is decoded and a call is set up to the telecommunication terminal. Following conversion of the data from the audio format to a format which is suitable for transmission in the voice band, the data are advantageously transmitted in the voice band to the telecommunication terminal using DSP technology, said telecommunication terminal preferably being an inexpensive terminal of conventional design. The data are advantageously output on the telecommunication terminal in audio form.

Other features which are considered as characteristic for the invention are set forth in the appended claims.

Although the invention is illustrated and described herein as embodied in a method for transmitting data from a data network to a telecommunication terminal, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagram showing the configuration of a conventional network for WAP push; and

FIG. 2 is a diagram of another network based on an embodiment according to the invention.

### DESCRIPTION OF THE PREFERRED EMBODIMENTS

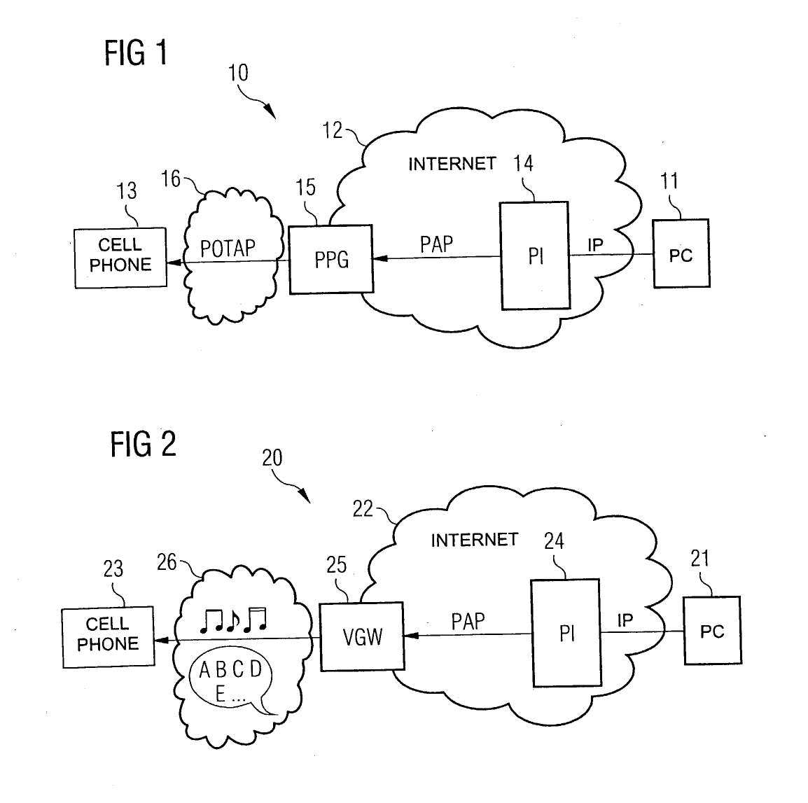

Referring now to the figures of the drawing in detail and first, particularly, to FIG. 1 thereof, there is shown the design of a network 10 for WAP push of data in line with standard WAP 1.2. In this context, a PC 11 is used to send a text message in the form of an e-mail to a mobile telephone 13 with WAP capability over the Internet 12.

In a first step, the e-mail is transmitted from the PC 11 to a server 14 using the IP protocol. The server 14, i.e., the “push initiator”, transmits the e-mail to a push proxy gateway 15 by means of WAP push using the push access protocol PAP. For this, the PAP uses messages in the XML (Extensible Markup Language) format, a meta-language which is compatible with the various protocols customary on the Internet 12, such as the HTTP (Hypertext Transfer Protocol). Following reception by the push proxy gateway 15, the PAP message containing the original text message is sent to the mobile telephone 13 using the complex push-over-the-air protocol (POTAP) format. In the present case, the owner of the mobile telephone 13 is currently driving a car. It is therefore very difficult to call up the text message on the display following reception, and it is quite dangerous or impossible to read it.

FIG. 2 shows the design of a network 20, which is similar to that of the network 10 from FIG. 1. Once more, a text message in the form of an e-mail is sent from a PC 21 to a mobile telephone 23 over the Internet 22.

When the e-mail arrives on the server 24, the text format of the message is converted to a binary audio format, the PCM-WAV format. The text message, which is now in audio format, is appended to a PAP message using MIME coding and is transmitted to a voice gateway 25. The coding is necessary because the MIME (Multi Purpose Internet Extension) application protocol permits binary files, such as the audio file in the present case, to be transmitted without prior conversion to a text file.

An HTTP-based implementation on the voice gateway 25 allows communication between the voice gateway and the server 23 using the push access protocol, and hence reception of the PAP message. On the voice gateway 25, the PAP message is decoded and a call is set up to the mobile telephone 23 via the mobile radio network 26. The text of the e-mail that is available in a binary audio format is converted on the voice gateway 26 to a format which is suitable for transmission in the voice band. Following acceptance of the connection between the voice gateway 25 and the mobile telephone 23, the message originally in text format is transmitted to the mobile radio telephone 23 in the voice band using DSP technology.

For reception, a conventional mobile telephone 23, i.e. one which does not have WAP capability, is used. The message is now output in audio form, i.e. the text of the e-mail is “read aloud”. In a similar manner to the previous example, the user of the mobile telephone 23 is currently driving a car in this case too. Simply by accepting the call, which is easy to do even when driving a car, he can then listen to the message, for example using a hands-free system, as a result of the message being output in voice form.

Following output of the content of the WAP-PUSH-MESSAGE or of the MIME-VOICE attachment, it is optionally possible to continue a voice dialog in line with the likewise standardized VOICEXML technology.

It will be readily understood that the embodiment of the invention is not limited to the exemplary descriptions presented above. Instead, it also covers a large number of modifications which are within the technical scope of those skilled in the pertinent art.

I claim:

1. A method for transmitting data from a data network to a telecommunication terminal, which comprises:
transmitting the data in the data network to a server;
converting a format of the data to a binary audio format on the server;
transmitting the data in audio format to a voice transmission gateway with a WAP push using push access protocol;
converting the data from the audio format to a format for transmission in the voice band with the voice transmission gateway; and
transmitting the data in the voice band to the telecommunication terminal via a telecommunication network, for outputting in audio format on the telecommunication terminal.

2. The method according to claim 1, which comprises converting the data on the server to a PCM-WAV format.

3. The method according to claim 1, which comprises appending the data in audio format on the server to a push access protocol message using MIME coding.

4. The method according to claim 1, wherein the voice transmission gateway receives and decodes messages in push access protocol format on an HTTP basis.

5. The method according to claim 1, which comprises transmitting the data from the voice transmission gateway to the telecommunication terminal in the voice channel using DSP technology.

6. The method according to claim 1, which comprises transmitting data originally in the form of music or sounds from the data network to the telecommunication terminal.

7. The method according to claim 1, which comprises transmitting data originally in text format from the data network to the telecommunication terminal.

8. The method according to claim 1, which comprises outputting the data from the data network using a conventional telecommunication terminal.

9. The method according to claim 1, which comprises outputting the data from the data network using a conventional telecommunication terminal without WAP capability.

10. A method for transmitting data from a data network to a telecommunication terminal, which comprises:
receiving the data in a server;
converting a format of the data to a binary audio format on the server;
transmitting the data in audio format to a voice transmission gateway with a WAP push using push access protocol;
coding the data from the audio format to a format for transmission in the voice band with the voice transmission gateway; and
transmitting the data in the voice band to the telecommunication terminal via a telecommunication network, for outputting in audio format on the telecommunication terminal.

11. A network for transmitting data from a data network to a telecommunication terminal, the network comprising:
a server connected to receive the data in data format and having a device for converting the data to an audio format and a device for transmitting messages in push access protocol format; and
a voice transmission gateway with an HTTP-based reception device for receiving and decoding messages in push access protocol format and a transmission device for transmitting data to the telecommunication terminal in a voice channel.

12. The network according to claim 11, wherein said server comprises a device for creating a message using the push access protocol, wherein the data have been appended to the message in audio format using MIME coding.

13. The network according to claim 11, wherein said voice transmission gateway comprises means for transmission in the voice band using DSP technology.

14. The network according to claim 11, wherein the network comprises at least one conventional telecommunication terminal.

15. The network according to claim 14, wherein the conventional telecommunication terminal is a terminal without WAP capability.
